(19) United States
(12) Patent Application Publication
(10) Pub. No.: US 2006/0164692 A1
(43) Pub. Date: Jul. 27, 2006

(54) Image forming apparatus

(75) Inventors: Michiko Fujiwara, Nara (JP); Takashi Kitagawa, Nara (JP); Shinji Imagawa, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/336,138

(22) Filed: Jan. 19, 2006

(30) Foreign Application Priority Data
Jan. 21, 2005 (JP) 2005-14481

(51) Int. Cl. H04N 1/40; G06K 15/00

(52) U.S. Cl. 358/3.21

(57) ABSTRACT

In one embodiment, an image forming apparatus that digitally performs image processing and correction processing of image information, and calculates toner consumption by performing a pixel count of an input multilevel image, includes a counting portion that counts, pixel by pixel, the input signal levels of an input multilevel image; a weighting coefficient table that stores weighting coefficients corresponding to the input signal levels; a weighting calculation portion that obtains weighting coefficients corresponding to the input signal levels from the weighting coefficient table and performs weighting of each pixel when counting the input signal levels with the counting portion; and a rewriting portion that rewrites the weighting coefficients stored in the weighting coefficient table; in which a process control is performed when the calculated toner consumption reaches a predetermined value.

### CROSS REFERENCE TO RELATED APPLICATIONS

This application claims priority under 35 U.S.C. § 119(a) on Patent Application No. 2005-14481 filed in Japan on Jan. 21, 2005, the entire contents of which are hereby incorporated by reference.

### BACKGROUND OF THE INVENTION

1. Field of Invention

The present invention relates to image forming apparatuses such as copy machines, laser beam printers, facsimile apparatuses, or the like that use an electrophotographic system wherein image processing and correction processing of image information is digitally performed.

2. Related Art

Generally, with image processing in electrophotographic apparatuses such as digital copy machines, a digital image signal input by an image input apparatus such as a scanner is output as an output image signal after performing such digital signal processing as input signal processing, region separation processing, color correction processing, black generation processing, zoom variable power processing, and the like, then performing filter processing with a spatial filter, and also performing halftone correction processing.

FIG. 7 shows an image processing control block diagram for a conventional digital copy machine. In order to perform this control, this conventional digital copy machine includes an input signal processing portion 110, a region separation processing portion 120, a color correction/black generation processing portion 130, a zoom variable power processing portion 140, a spatial filter processing portion 150, a halftone correction processing portion 160, a pixel count portion 170, and a toner consumption calculating portion 180.

The image processing in this sort of digital copy machine is explained with reference to the flowchart in FIG. 8.

First, the digitally input image signal of the original read into a scanner or the like is input into the input signal processing portion 110, and preprocessing for the subsequent image processing, input gamma correction and conversion in image adjustment and the like are performed (Step S101, S102).

Next, this image signal is input into the region separation processing portion 120, regions such as text regions and halftone dot photograph regions are judged, and an identification signal showing the judgment (a region separation identification signal) is added to each region (Step S103). This region separation identification signal is used when, in the spatial filter processing portion 150, which is used for subsequent processing, performing processing differing for each region, for example, performing smoothing filter processing for halftone dot regions or performing edge emphasis filter processing for text regions, or in the halftone correction processing portion 160, which is also used for subsequent processing, when changing the halftone gamma properties to properties with clearer grayscale difference properties.

The color correction/black generation processing performed in the following color correction/black generation processing portion 130 (Step S104) is a necessary process when the apparatus is a color apparatus, and this processing converts the RGB image signal sent from the region separation processing portion 120 to a CMYK (yellow, magenta, cyan, black) image signal, which is the final output method.

After the zoom variable power processing in the zoom variable power processing portion 140 (Step S105), the image signal converted to CMYK is input to the spatial filter processing portion 150. In the spatial filter processing portion 150, a spatial filter is chosen from a spatial filter table in accordance with the region separation identification signal, the image mode setting state and the like, and spatial filter processing is performed on the image signal converted to CMYK (Step S106). The spatial filter table is a table group of filter coefficients referred to when performing the spatial filter processing, wherein it is possible to select a desired table according to the circumstances.

Correction of the halftone gamma properties is performed (Step S107) in the next halftone correction processing portion 160, in order to correct the output properties at an engine portion.

Further, the image signal after halftone correction processing is input to the pixel count portion 170, and is summed by the counter while weighting each CMYK signal at every pixel (Step S108). Then, the output image signal flows to the LSU or LED engine output (Step S10). In the toner consumption calculating portion 180, the toner consumption for each color is calculated from the pixel count sum value summed in the pixel count portion 170 (Step S109). The calculated toner consumption is used for accumulation of toner consumption data and determining when the toner is near the end of its life.

The engine of the type of digital copy machine described above is controlled such that a constant toner density and image output is output from the beginning until the end of toner life, by controlling the setting of process conditions such as developing bias values and the amount of exposure and toner density correction, in order to suppress aging of photosensitive bodies, developer, and the like.

FIG. 9 is a flowchart showing a simplified view of the toner density control processing, which is a control performed on the engine side. With this toner density control processing, the control value of the toner density sensor is determined from the values of the life counter and environment sensor (Step S111, S112), and ON/OFF of the toner refilling is controlled according to that value. That is, when the toner density is low (when judged YES in Step S113), the toner refill is turned ON, and controlled such that toner is refilled (Step S114). Thereby, the toner density is controlled such that it is always kept constant.

FIG. 10 is a flowchart showing a simplified view of the halftone gamma correction processing with the toner patch. With this halftone gamma correction processing, a toner patch is formed on a photosensitive body, a transfer belt or the like with a halftone pattern (tone) according to a predetermined fixed input level (Step S121 to S123), and the quantity of light reflected from the toner patch is read by a reading apparatus such as an optical sensor (Step S124). Next, the sensor output level of the read toner patch is compared to the standard target level which is the target level, and the amount of correction is calculated (Step S125). Then, according to that calculated amount of correction, the current halftone gamma correction table is revised (Step S126), and thereby, controlled such that constant halftone gamma properties are always obtained.

Next, the calculation of the toner consumption noted above will be described in detail. The processing stated below is performed with respect to each CMYK color (each input CMYK signal).

The pixel count portion 170 performs a pixel count as described below for the multilevel image expressed by the input image signal. As shown in FIG. 7, the pixel count portion 170 is provided with a counting means 171, a weighting calculation means 172, a weighting coefficient table 173, and a summing means 174.

The counting means 171 counts each pixel of the input multilevel image (for example, multi-grade images such as 16-grade and 256-grade images). That is, it counts the input signal (grade) of each pixel constituting a multilevel image, for example, an input signal level such as 0 to 15 (in the case of a 16-grade image wherein the input signal level takes on the levels 0 to 15).

The weighting calculation means 172 performs weighting of each pixel when counting the pixels with the counting means 171. Specifically, the weighting calculation means 172 obtains a weighting coefficient corresponding to the input signal level of each pixel from the weighting coefficient table 173, and multiplies the obtained weighting coefficients by the input signal levels, thus obtaining a pixel count value. Respective weighting coefficients corresponding to a plurality of input signal levels are stored in the weighting coefficient table 173. In this way, in the pixel count portion 170, a pixel count value of each pixel is obtained by the counting means 171, the weighting calculation means 172, and the weighting coefficient table 173.

Summation of the pixel count values obtained for each pixel is performed by the summing means 174. That is, the summing means 174 sums the pixel count value for each pixel wherein a weighting coefficient has been multiplied by the input signal level by the weighting calculation means 172, for all the pixels of the input multilevel image. In this way, based on the sum value of the pixel count calculated by the pixel count portion 170, the toner consumption calculating portion 180 calculates the toner consumption of the output image.

The weighting coefficients stored in the weighting coefficient table 173 are fixed values set in advance. An example of the weighting coefficient table 173 when the input signal takes on 16 levels from 0 to 15 is shown in the following Table 1.

TABLE 1
Conventional Art
Weighting Coefficient Table (Fixed)

| | Signal input level | Weighting coefficient |
|---|---|---|
| Area 1 | 0 to 4 | 0 |
| Area 2 | 5 to 8 | 1 |
| Area 3 | 9 to 12 | 3 |
| Area 4 | 13 to 15 | 4 |

Table 1 is divided into four areas (area 1 to area 4) corresponding to input signal levels for different amounts of toner consumption, and a weighting coefficient is set for each area. When counting pixels, weighting is performed with the weighting coefficient, which is divided into four areas, set corresponding to the respective input signal levels that take on the levels 0 to 15.

FIG. 11 shows the relationship between the weighting coefficient table signal input levels divided into the four areas shown in Table 1 and the corresponding weighting coefficients. As shown in FIG. 11, the total area of the rectangular portions roughly matches the area of the curve showing the toner consumption properties, and therefore it is possible to predictably calculate the toner consumption from the pixel count sum value after weighting.

Image forming apparatuses have been proposed wherein toner thin layer nonuniformities are efficiently prevented when successively printing images which have an extremely small toner consumption rate (for example, see JP2002-287499A). Specifically, image forming apparatuses have been disclosed that have a pixel counter, a recording page counter, and a toner consumption means, wherein when a number of pixels not more than a predetermined value have been counted during a predetermined number of recording pages, during process control, along with performing a judgment that a consumption action is executed by the toner consumption means, the toner consumption means is created at the same time as creation of the process control toner patch when executing the consumption action.

However, in conventional electrophotographic apparatuses such as digital copy machines, there were the following problems.

As stated above, when performing the pixel count and calculating the toner consumption of the output image, a weighting coefficient table storing fixed weighting coefficients set in advance was used. However, when using this sort of weighting coefficient table, as shown in FIG. 11, the weighting coefficient determined from the weighting coefficient table for a particular input signal level may differ greatly from the value on the curve that shows the toner consumption properties for that input signal level. Therefore, there is the problem that the toner consumption cannot be accurately calculated from the sum value of the pixel count after weighting.

In this case, for example, as shown in FIG. 12, a method is conceivable wherein the difference between the actual toner consumption properties and the toner consumption calculated by the pixel count is decreased using a weighting coefficient table in which the weighted coefficients of the values that can be taken from the input signal levels, that is, the number of gradations of the input signal, are apportioned. However, when the toner consumption properties change from curve D shown by the solid line in FIG. 12 to the broken line shown by curve E due to individual differences or toner life, it is not possible to follow the change in the toner consumption properties by simply raising the number of gradations of the weighting coefficient table, and inaccurate toner consumption that differs from the actual toner consumption is calculated. When process control is performed based on inaccurate toner consumption, for example, when the calculated toner consumption is less than the actual toner consumption, there is the problem that the timing of the process control becomes too late, and it is not possible to keep the density of the output image constant.

### SUMMARY OF THE INVENTION

The present invention was made in light of the problems in the conventional technology mentioned above, and it is an object thereof to provide an image forming apparatus that can accurately calculates toner consumption regardless of individual differences and toner life, and determines the timing at which process control is performed based on accurate toner consumption.

The image forming apparatus of the present invention may be an image forming apparatus that, for each pixel of an input multilevel image, obtains toner consumption by summing, and that includes a weighting coefficient table that stores weighting coefficients corresponding to input signal levels that express the pixels of the multilevel image; a weighting calculation portion (weighting calculation means) that, for each pixel of the multilevel image, obtains a weighting coefficient corresponding to the input signal level from the weighting coefficient table, and performs weighting of the input signal level based on the weighting coefficient; a summing portion (summing means) that obtains toner consumption by summing calculation values that have been weighted by the weighting calculation portion; and an adjusting portion (adjusting means) that can adjust the weighting coefficients stored in the weighting coefficient table, in which when the toner consumption calculated by the summing portion reaches a predetermined value, a process control is performed to adjust a toner image density.

Also, a configuration may be adopted in which the process control is performed based on the density of the toner image which is formed.

Alternatively, the image forming apparatus of the present invention may be an image forming apparatus that, for each pixel of an input multilevel image, obtains toner consumption by summing, characterized by including a weighting coefficient table that stores weighting coefficients corresponding to input signal levels that express the pixels of the multilevel image; a weighting calculation portion (weighting calculation means) that, for each pixel of the multilevel image, obtains a weighting coefficient corresponding to the input signal level from the weighting coefficient table, and performs weighting of the input signal level based on the weighting coefficient; a summing portion (summing means) that obtains toner consumption by summing calculation values that have been weighted by the weighting calculation portion; and a rewriting portion (rewriting means) that rewrites the weighting coefficients stored in the weighting coefficient table.

Also, the image forming apparatus of the present invention may further include a reading portion (reading means) that reads a toner patch, and the rewriting portion may form a plurality of toner patches having mutually differing tones on a photosensitive body or transfer belt, read the toner patches with the reading portion, calculate halftone gamma properties based on the result of reading the toner patches, and rewrite the weighting coefficients stored in the weighting coefficient table according to the calculated halftone gamma properties.

With an image forming apparatus having this sort of configuration, because the weighting coefficients stored in the weighting coefficient table are varied or rewritten, the weight of input signal levels based on the weighting coefficients of the weighting coefficient table can be matched to the actual toner consumption properties. That is, even when actual toner consumption properties have changed due to individual differences or toner life, it is possible to change the weighting coefficients stored in the weighting coefficient table so that they follow this change in toner consumption properties, and the calculation of toner consumption properties can be optimized. As a result, it is possible to accurately calculate toner consumption regardless of individual differences or toner life, and an optimal timing can be determined for performing the process control.

### BRIEF DESCRIPTION OF THE DRAWINGS

FIG. 1 is a control block diagram showing the image processing in the image forming apparatus according to an embodiment of the present invention.

FIG. 2 is a flowchart showing the processing of the toner consumption calculation for a single pixel.

FIG. 3 is a diagram showing the way in which the weighting coefficient table is rewritten.

FIG. 4 is a flowchart showing the rewrite processing of the weighting coefficient table.

FIG. 5A shows an example of density detection patches formed by changing the developing bias, and FIG. 5B shows a regression curve of the developing bias and the density.

FIG. 6 shows the configuration of the vicinity of a photosensitive drum during adjustment processing.

FIG. 7 is a control block diagram showing the image processing in an image forming apparatus according to the conventional technology.

FIG. 8 is a flowchart showing the image processing in an image forming apparatus according to the conventional technology.

FIG. 9 is a flowchart showing a simplified view of the toner density control processing of the conventional technology.

FIG. 10 is a flowchart showing a simplified view of the halftone gamma correction processing by a toner patch of the conventional technology.

FIG. 11 is a diagram showing the relationship between the signal input level of the weighting coefficient table of the conventional technology and the corresponding weighting coefficients.

FIG. 12 is a diagram showing the relationship between the signal input level of the weighting coefficient table of the conventional technology and the corresponding weighting coefficients.

### DESCRIPTION OF THE PREFERRED EMBODIMENTS

Hereinafter, an embodiment of the present invention will be described with reference to the accompanying drawings, as an aid to understanding the present invention. The following embodiment is a specific example of the present invention, and is not of a nature limiting the technical scope of the present invention.

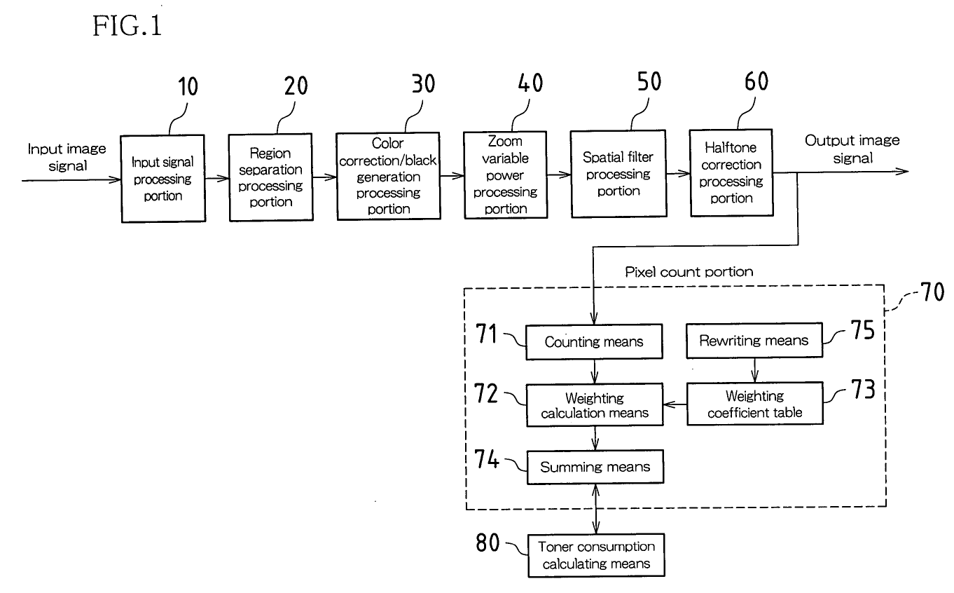

FIG. 1 is a control block diagram showing the image processing in the image forming apparatus (digital electrophotographic apparatus) according to an embodiment of the present invention. As shown in FIG. 1, this digital electrophotographic apparatus includes an input signal processing portion 10, a region separation processing portion 20, a color correction/black generation processing portion 30, a zoom variable power processing portion 40, a spatial filter processing portion 50, a halftone correction processing portion 60, a pixel count portion 70, and a toner consumption calculating portion (toner consumption calculating means) 80. In the digital electrophotographic apparatus, a digitally input image signal of an original read by scanner or the like, not shown in the drawings, passes through the input signal processing portion 10, the region separation processing portion 20, the color correction/black generation processing portion 30, the zoom variable power processing portion 40, the spatial filter processing portion 50, and the halftone correction processing portion 60, and is output as an output image signal.

The image processing in the digital electrophotographic apparatus configured in this manner will now be explained.

In the input signal processing portion 10, preprocessing for subsequent image processing, input gamma correction and conversion in image adjustment and the like are performed on the digitally input image signal of an original read by scanner or the like not shown in the drawings.

In the region separation processing portion 20, regions such as text regions and halftone dot photograph regions are judged, and an identification signal showing the judgment (a region separation identification signal) is added to each region. This region separation identification signal is used when, in the spatial filter processing portion 50, which is used for subsequent processing, performing processing differing for each region, for example, performing smoothing filter processing for halftone dot regions or performing edge emphasis filter processing for text regions, or in the halftone correction processing portion 60, which is also used for subsequent processing, when changing the halftone gamma properties to properties with clearer grayscale difference properties.

In the color correction/black generation processing portion 30, the RGB image signal sent from the region separation processing portion 20 is converted to a CMYK (yellow, magenta, cyan, black) image signal, which is the final output method. In the zoom variable power processing portion 40, variable power processing is performed on the CMYK image signal converted by the color correction/black generation processing portion 30.

In the spatial filter processing portion 50, a spatial filter is selected from the spatial filter table according to the previously mentioned region separation identification signal, the image mode setting state and the like, and spatial filter-processing is performed on the image signal converted to CMYK. In the halftone correction processing portion 60, a correction of the halftone gamma properties is performed on the image signal on which spatial filter processing was performed. Then, the image signal after halftone correction processing in the halftone correction processing portion 60 is output as an output image signal.

In the pixel count portion 70, a pixel count is performed for the image signal after halftone correction processing in the halftone correction processing portion 60, while multiplying a weighting coefficient to each CMYK signal at every pixel. In the toner consumption calculating portion 80, toner consumption is calculated for each color (CMYK) from the sum value of the pixel count.

Below, the toner consumption calculation processing in the digital electrophotographic apparatus is explained in detail. The process referred to below is performed for each CMYK color (each input CMYK signal).

The pixel count portion 70 performs a pixel count as described below for the input multilevel image. As shown in FIG. 1, the pixel count portion 70 is provided with a counting means 71, a weighting calculation means 72, a weighting coefficient table 73, a summing means 74, and a rewriting means 75.

The counting means 71 counts each pixel of the input multilevel image (for example, multi-grade images such as 16-grade and 256-grade images). That is, it counts the input signal (grade) of each pixel constituting a multilevel image, for example, an input signal level such as 0 to 15 (in the case of a 16-grade image wherein the input signal level takes on the levels 0 to 15).

The weighting calculation means 72 performs weighting of each pixel when counting the pixels with the counting means 71. Specifically, the weighting calculation means 72 obtains a weighting coefficient corresponding to the input signal level of each pixel from the weighting coefficient table 73, and multiplies the obtained weighting coefficient by the input signal levels. Respective weighting coefficients corresponding to a plurality of input signal levels are stored in the weighting coefficient table 73. In this way, in the pixel count portion 70, a pixel count value of each pixel is obtained by the counting means 71, the weighting calculation means 72, and the weighting coefficient table 73.

Then, summation of the pixel count values obtained for each pixel is performed by the summing means 74. That is, the summing means 74 sums the pixel count value of each pixel having a weighting coefficient multiplied by the input signal level by the weighting calculation means 72, for all the pixels of the input multilevel image. A rewriting means 75, as described below, rewrites the weighting coefficient table 73. The toner consumption calculating portion 80 calculates the toner consumption of the output image, based on the sum value of the pixel count values calculated by summed by the summing means 74.

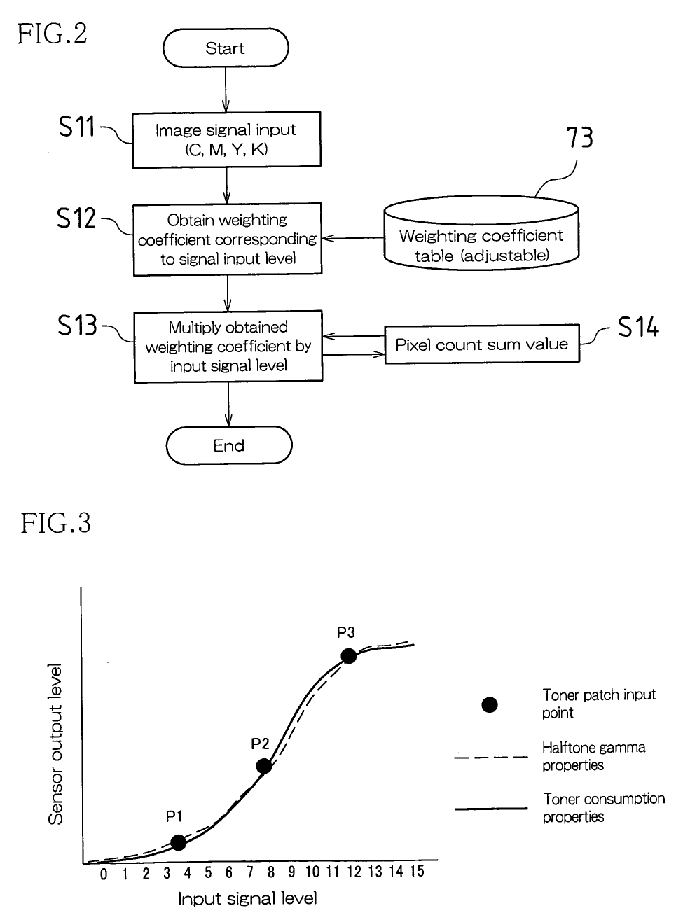

The toner consumption calculation for a single pixel is explained using FIG. 2. As shown in FIG. 2, when the signal for a single pixel that is part of the multilevel image is input into the pixel count portion 70 (Step S11), the input signal level is counted by the counting means 71. Next, a weighting coefficient corresponding to the input signal level is obtained by the weighting calculation means 72 from the weighting coefficient table 73 (Step S12), this weighting coefficient is multiplied by the pixel count value of the input signal level from the counting means 71, and a pixel count value for a single pixel is obtained (Step S13). The pixel count value for a single pixel obtained in this way corresponds to the toner consumption of a single pixel. The pixel count values calculated for each single pixel are sequentially summed by the summing means 74, and saved as a pixel count sum value (Step S14). The pixel count sum value is a sum of pixel count values for all of the input pixels, and based on this pixel count sum value, the toner consumption of the output image can be calculated by the toner consumption calculating portion 80.

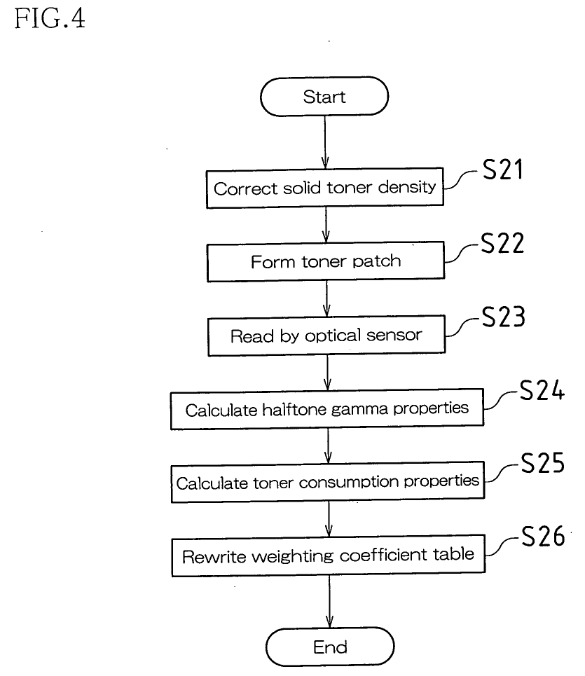

Next, the rewriting of the weighting coefficient table 73 is explained using FIGS. 3 and 4. The weighting coefficients stored in the weighting coefficient table 73 are adjustable, unlike in the conventional technology, and can be rewritten by the rewriting means 75. One example of the weighting coefficient table 73, for the case of a 16-level input signal level that takes on input signal levels 0 to 15, is shown in the following Table 2.

TABLE 2
Weighting Coefficient Table (Adjustable)

| Signal input level | Weighting coefficient |
|---|---|
| 0 | X0 |
| 1 | X1 |
| 2 | X2 |
| 3 | X3 |
| 4 | X4 |
| 5 | X5 |
| 6 | X6 |
| 7 | X7 |
| 8 | X8 |
| 9 | X9 |
| 10 | X10 |
| 11 | X11 |
| 12 | X12 |
| 13 | X13 |
| 14 | X14 |
| 15 | X15 |

In Table 2, the weighting coefficients (X0 to X15) corresponding to the input signal levels 0 to 15 are each adjustable. The weighting coefficients X0 to X15 are rewritten as follows by the rewriting means 75.

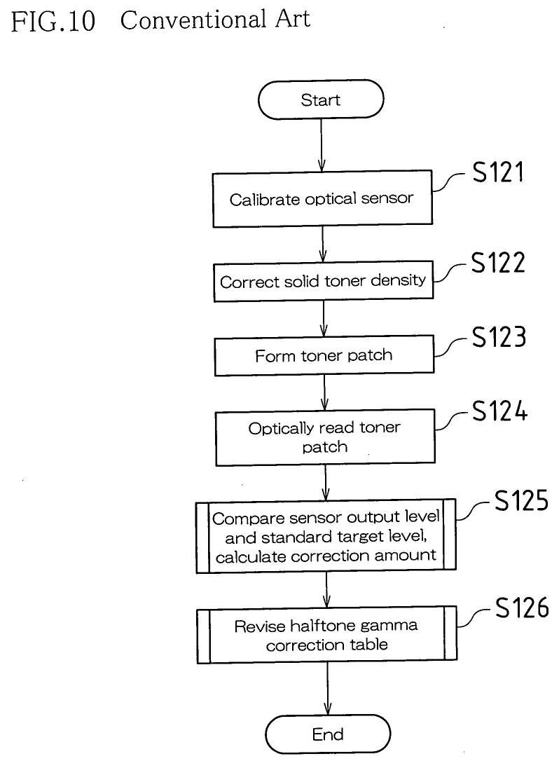

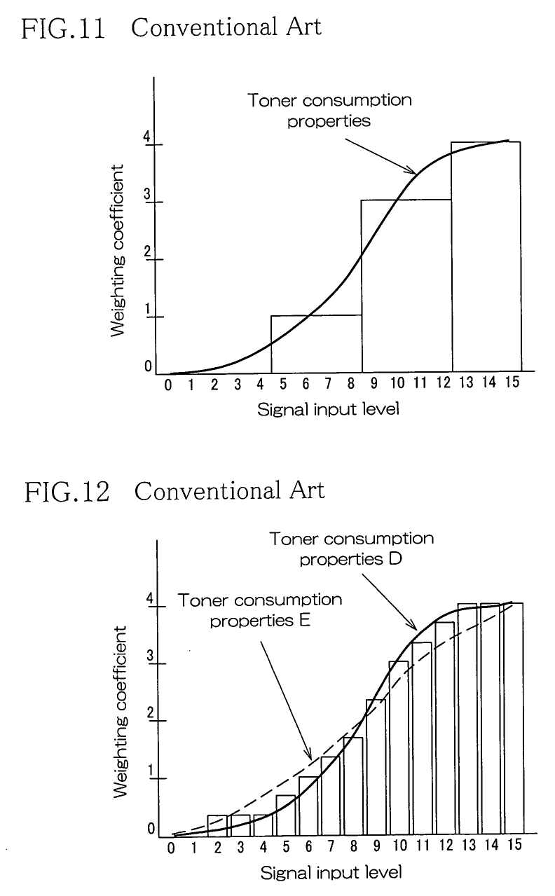

First, after the solid toner density has been corrected (Step S21), a plurality of toner patches having mutually differing tones, as shown by points P1 to P3 in FIG. 3, are formed on the photosensitive body or transfer belt (Step S22). That is, halftone toner patches for a plurality of input points set in advance are formed on the photosensitive body or transfer belt. Then, the amount of reflected light of those toner patches is read by a reading means such as an optical sensor (Step S23). In FIG. 3, the vertical axis is the sensor output of the reading means such as an optical sensor, and the horizontal axis is the signal input level (grade). There is no particular limitation to the number of input points, but it is preferable to have at least three points. The procedure of above Steps S21 to S23 is similar to Steps S122 to S124 in the halftone gamma correction processing shown in FIG. 10, stated above in the section explaining the related art, and so the following procedure may also be performed, using the results of this halftone gamma correction processing.

Next, based on the sensor output of toner patches for a plurality of input points, the halftone gamma properties as shown by the broken line in FIG. 3 are calculated (Step S24). Based on the calculated halftone gamma properties, the toner consumption properties for the signal input levels as shown by the solid line in FIG. 3 are calculated (Step S25). The weighting coefficients are determined based on the toner consumption properties calculated in this manner, and the weighting coefficients stored in the weighting coefficient table 73 are rewritten to the determined weighting (Step S26). In the case of Table 2, the weighting coefficients X0 to X15 corresponding to the input signal levels 0 to 15 are rewritten according to the toner consumption properties.

In this way, a pixel count of the input multilevel image is performed in the pixel count portion 70 using the weighting coefficients rewritten by the rewriting means 75, and the toner consumption of the output image is calculated by the toner consumption calculating portion 80.

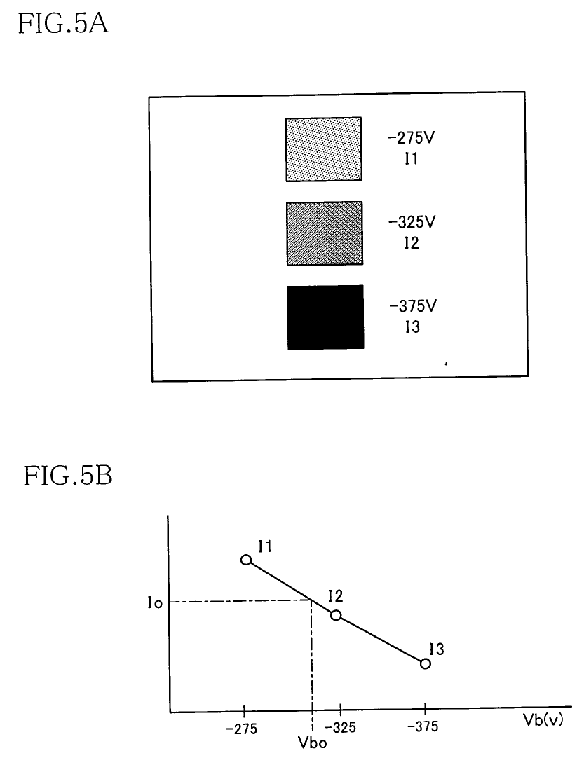

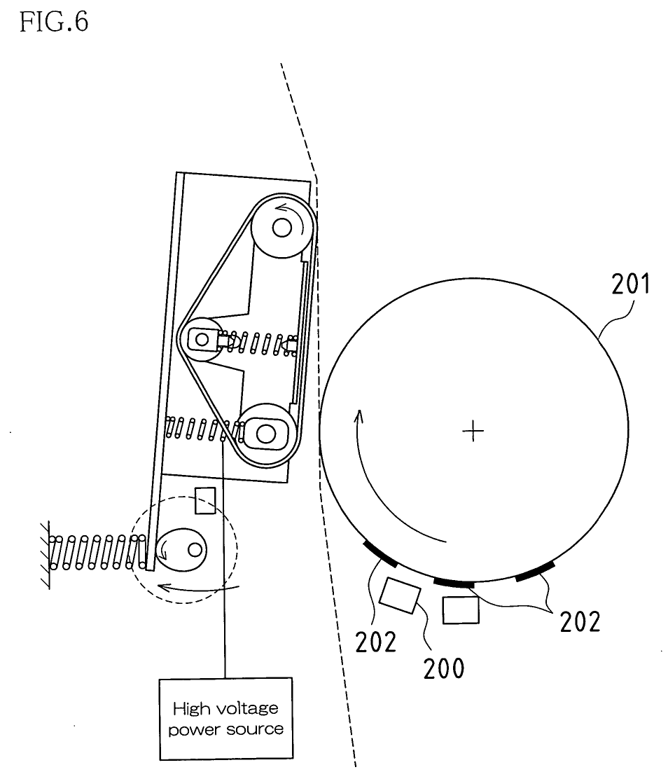

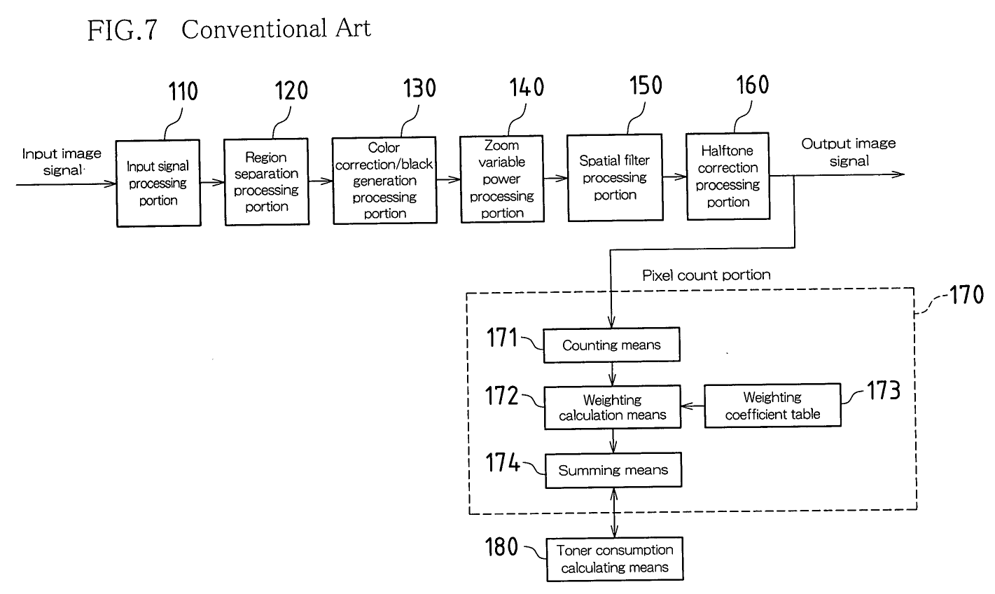

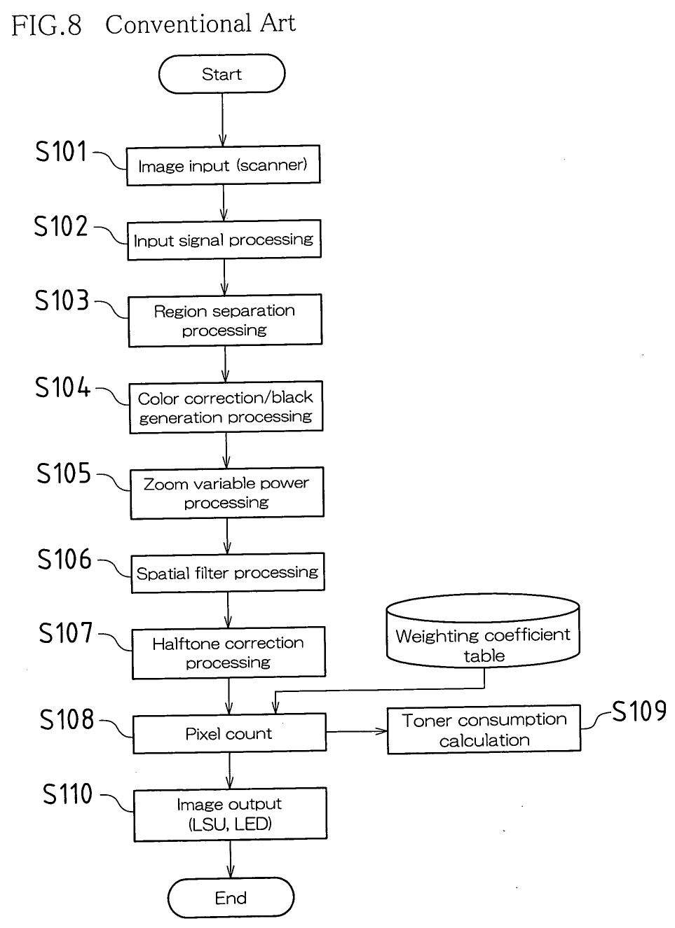

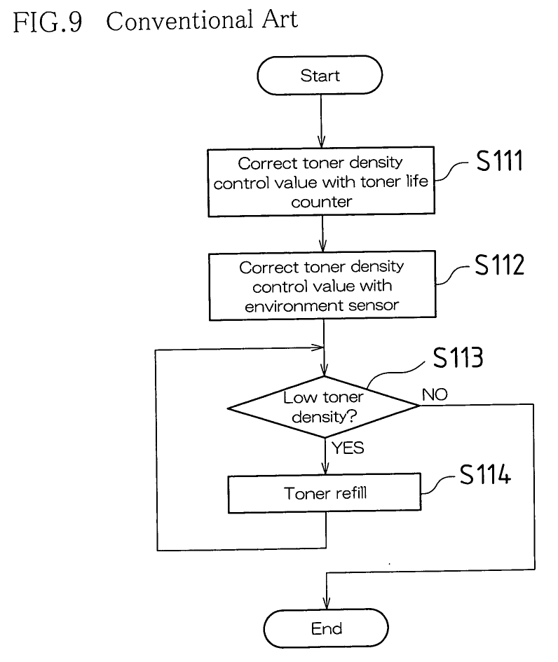

In this way, even when actual toner consumption properties have changed due to individual differences or toner life, it is possible to follow the changes in toner properties and rewrite the weighting coefficient table 73, and the calculation of toner consumption properties can be optimized. As a result, toner consumption can be accurately calculated irrespective of individual differences or toner life. That is, it is possible to hold the discrepancy between the actual toner consumption and the toner consumption calculated using the weighting coefficient table 73 rewritten by the rewriting means 75 to a low level. When the sum toner consumption obtained by the method described above reaches a predetermined value, the process control described below is executed. For example, as shown in FIG. 5A, with image forming conditions kept at grid bias −500 V, laser power Po=0.43 mW, and laser PWM duty ratio 100%, developing bias Vb is changed to equal −275 V, −325 V, and −375 V, and as shown in FIG. 6, three 20 mm×20 mm density detection patches 202 are formed on the circumferential face of a photosensitive drum 201.

When detecting the formed density detection patches 202, one density detection patch 202 is read by a patch image detector 200 configured from a reflex optical sensor (corresponding to an example of the reading means described above), sampling is performed for about ten-odd points, and an average is calculated with nearly maximum and nearly minimum values removed. The output of the patch image detector 200 corresponding to the density of the three density detection patches 202 is respectively made I1, I2, and I3.

As shown in FIG. 5B, a regression curve is obtained of the developing bias and density, and from this regression curve a developing bias Vb0 is obtained, which will be a predetermined density I0. Here, the predetermined density I0 is the density that should be obtained when the laser PWM duty ratio has been set to 80%. That is, the developing bias Vb0 is a value of the developing bias that makes it possible to obtain the desired density by adjusting the amount of exposure. When this developing bias Vb0 is obtained, the present developing bias value changes to the developing bias Vb0.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus that, for each pixel of an input multilevel image, obtains toner consumption by summing, comprising:
a weighting coefficient table that stores weighting coefficients corresponding to input signal levels that express the pixels of the multilevel image,
a weighting calculation portion that, for each pixel of the multilevel image, obtains a weighting coefficient corresponding to the input signal level from the weighting coefficient table, and performs weighting of the input signal level based on the weighting coefficient,
a summing portion that obtains toner consumption by summing calculation values that have been weighted by the weighting calculation portion, and
an adjusting portion that can adjust the weighting coefficients stored in the weighting coefficient table, wherein
when the toner consumption calculated by the summing portion reaches a predetermined value, a process control is performed to adjust a toner image density.

2. The image forming apparatus according to claim 1, wherein the process control is performed based on the density of the toner image which is formed.

3. An image forming apparatus that, for each pixel of an input multilevel image, obtains toner consumption by summing, comprising:
a weighting coefficient table that stores weighting coefficients corresponding to input signal levels that express the pixels of the multilevel image,
a weighting calculation portion that, for each pixel of the multilevel image, obtains a weighting coefficient corresponding to the input signal level from the weighting coefficient table, and performs weighting of the input signal level based on the weighting coefficient,
a summing portion that obtains toner consumption by summing calculation values that have been weighted by the weighting calculation portion, and
a rewriting portion that rewrites the weighting coefficients stored in the weighting coefficient table.

4. The image forming apparatus according to claim 3,
further comprising a reading portion that reads a toner patch,
wherein the rewriting portion:
forms a plurality of toner patches having mutually differing tones on a photosensitive body or transfer belt,
reads the toner patches with the reading portion,
calculates halftone gamma properties based on the result of reading the toner patches, and
rewrites the weighting coefficients stored in the weighting coefficient table according to the calculated halftone gamma properties.
